(19) United States
(12) Patent Application Publication
(10) Pub. No.: US 2012/0209690 A1
(43) Pub. Date: Aug. 16, 2012

(54) WATCH AND WIN TECHNIQUES

(75) Inventors: Howard Ganz, North York (CA); Karl Joseph Borst, Woodbridge (CA)

(73) Assignee: Ganz, Woodbridge (CA)

(21) Appl. No.: 13/397,270

(22) Filed: Feb. 15, 2012

Related U.S. Application Data
(60) Provisional application No. 61/443,077, filed on Feb. 15, 2011.

(51) Int. Cl. G06Q 30/02

(52) U.S. Cl. 705/14.39; 705/14.12

(57) ABSTRACT

A watch and win or read and win system in which the user receives information about a subject being advertised, watches or reads it, and then answers questions. If the questions are answered properly, then the user gets a virtual item that can be used in the virtual world. In one embodiment, the virtual item is related to the item being viewed. This can be used to create a more effective form of advertising.

This application claims priority from provisional application No. 61/443,077, filed Feb. 15, 2011, the entire contents of which are herewith incorporated by reference.

### BACKGROUND

Our U.S. Pat. No. 7,421,569, filed Dec. 30, 2004 discusses a system of interacting with a virtual representation of a real world product. According to this system, a user can buy a toy such as 100 which is associated with a special code. The toy 100 exists in the real world, and the code forms a key to the virtual world 110. The user enters the code 105 on a website and enters the virtual world 110.

The virtual world 110 provides activities and views with which the user can interact. The virtual world, as part of the interaction, provides a virtual replica 115 of the actual toy 100. Users can carry out various activities on the website using their virtual version of the toy. For example, the user can form a house with rooms, furniture, things, clothing, and other things. The user can also carry out activities to earn cash, and purchase virtual items using that cash.

### SUMMARY

According to one embodiment the user can click on or select any advertisement which is watch and win enabled, to see more detail about the advertisement, answer questions about the advertisement, and win some kind of prize for answering properly. In one embodiment, the watch and win presentation shows a video, and in another embodiment the watch and win shows a reading excerpt from which excerpt should be read.

According to one embodiment, the watch and win presentation is usable in a web site which shows a virtual world, and provides a virtual item for use in the virtual world.

### BRIEF DESCRIPTION OF THE DRAWINGS

In the Drawings:

FIG. 1 shows a basic block diagram of a virtual world website;

FIG. 2 shows a flowchart of the watch and win;

FIG. 3 shows a flowchart of the watch and win embodiment for a reading subject;

FIGS. 4 and 5 show an advertisement for a pet of the month;

FIG. 6 shows the watch and win welcome screen;

FIG. 7 shows the beginning screen with the watch and win instructions;

FIGS. 8 and 9 show the countdown screen;

FIGS. 10 and 11 show the question screen including check boxes with answers;

FIG. 12 shows the win screen;

FIG. 13 shows a screen for enabling the prize which is one to be sent to a different website;

FIG. 14 shows the screen for answering incorrectly to one or more questions;

FIG. 15 shows the screen that a user gets when entering the other website if the reward has been transferred to the other website;

FIGS. 16 and 17 shows a watch and win system used with a video;

### DETAILED DESCRIPTION

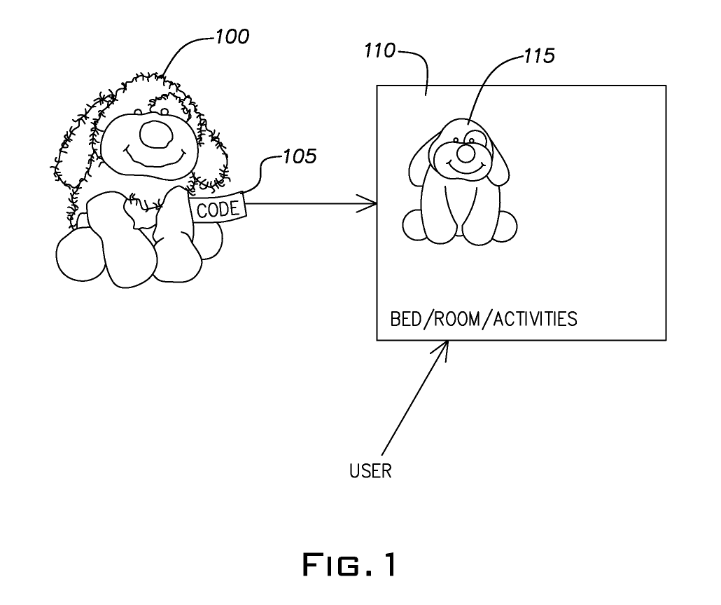

The present application describes additional aspects, actions and activities and additional structure, for adding to a website of the type described in our co-pending application, and as shown generally in FIG. 1. It should be understood, however, that the aspects described herein are not limited to use with the system described in FIG. 1. These aspects can be used with other kinds of websites, for example, any website that allows user interaction can be used with this system. An embodiment describes new operations using the website illustrated in FIG. 1, and adapting that website to optimize its use with advertising.

In the embodiment, and in websites such as the Webkinz® website, users carry out activities to earn virtual cash that is usable on the website. The virtual cash can be used to purchase items that are usable on the website, e.g., virtual food, furniture, virtual clothing that are usable with virtual characters that can be controlled by the user, or other items.

Another embodiment describes an arcade, called the “GanzWorld Arcade”. The Ganz World arcade provides games, and anyone can play those games. According to an embodiment, the games provide virtual cash as a prize awarded for winning, achieving a goal in such games, or otherwise successfully participating in those games. The virtual cash which is obtained from winning or otherwise participating in those games can similarly be used to purchase items that are usable on the website along with the virtual characters.

There can also be a news section, called “Webkinz Newz” in the present embodiment, on the website or linked to the website. This section informs a user about different newsworthy events relating to the website, such as new games added to the website, new product offerings, etc . . . .

One of the ways of making money from an interactive website such as this is by advertising. Advertisers will typically be expected to pay more if they are going to get more of the user's attention.

The present application describes a system that enhances the website in a way that increases the user's attention to the advertisements.

According to embodiments, the user can view a presentation about an advertising topic on the website. The user is asked questions about the topic and earns points for properly answering the question meaning that the user has actually watched the presentation.

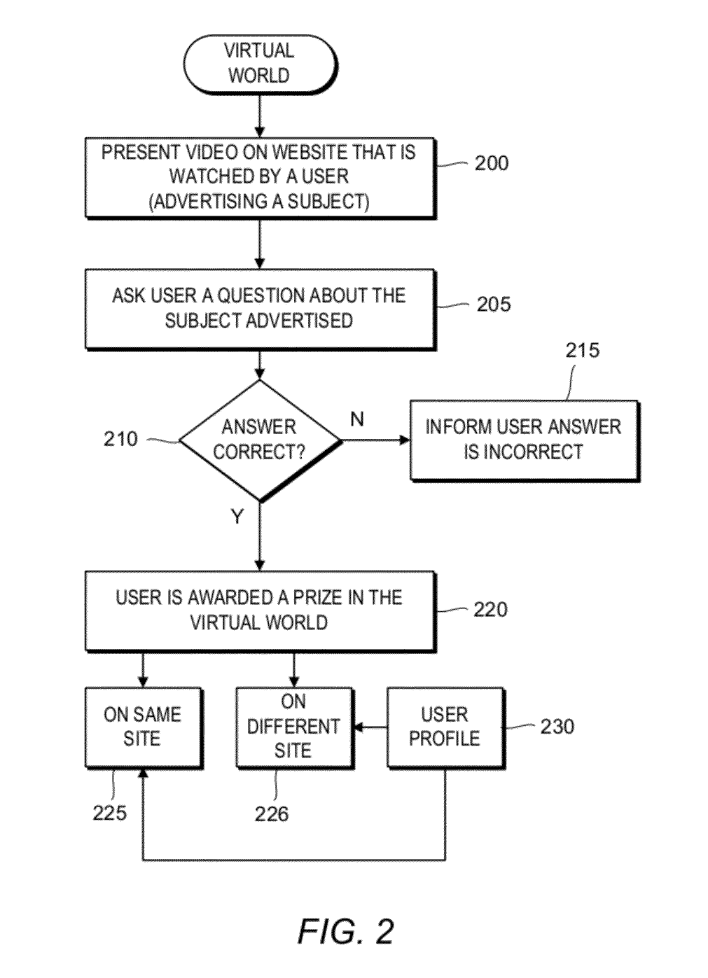

In a first embodiment, the advertisement is a video that can be watched on the website, for example, and can be an advertising video. This is shown as 200 in the flowchart of FIG. 2 for the video embodiment.

After the user watches the video, the computer system asks the user one or more questions about the content of the video at 205. At 210 it is determined if the user has answered the question(s) correctly. If not, a notification is presented to the user by the computer system, notifying the user that the answer given is incorrect at 215, and the process is concluded. If, at 210, it is determined that the user answered the question(s) correctly, the user is awarded a prize by the computer system that is usable within the virtual world of the website. According to one embodiment, that prize is related in its subject matter to the content of the video, and hence places a greater emphasis on the subject matter of the advertisement.

According to another embodiment, awarding prizes in response to a user entering a correct answer about an advertisement can be performed in association with user accounts. The user may have an account on a first website, referred to herein as “site number one”. When the user is logged in to site number one, the user can participate in various activities (e.g., play games, read the news, review advertisements, care for virtual characters, interact with other virtual characters, etc . . . ) on site number one and receive and enter codes for items that are usable on site number one. In response to entering such a code into the website the user can optionally be granted access to a virtual item on the website corresponding to the code. In this embodiment, the “prize” awarded to the user for correctly answering one or more questions about the advertisement can optionally include a code, virtual cash, etc . . . that is usable only on the same site on which it was earned, shown as 225.

According to a first alternative embodiment shown as 226, the computer system provides a code for another site other than the site the user is on and/or logged on to. Therefore, for example, the user is logged in to site number one, but when the user answers the question correctly, the system gives the user a code that is redeemable and good for an item on a second, different website, referred to herein as “site number two”. Although different, site number one and site number two can optionally be connected, such as by a common owner or proprietor for example, or can be completely unrelated.

According to another embodiment, the user is logged in to site number one. The user's profile for site number one includes information about that user's login information on site number two. Therefore, when the user answers the question correctly, the user is awarded credits, a code or another prize directly on site number two, and such prize is stored in the user's account on website number two.

Another embodiment allows using the prizes themselves as part of the advertising. For example, the video can be a video about cornflakes, which informs the user of various different ways the cornflakes are good for the user. The user might then be presented with questions about cornflakes. For a user who is logged into the Webkinz site (which can be considered website number one for the present embodiment), that user has access to a virtual world, with virtual characters. Answering the questions about cornflakes correctly on the Webkinz site provides the user with a virtual bowl of cornflakes on the Webkinz site that the user can feed to the user's virtual pet on the Webkinz site.

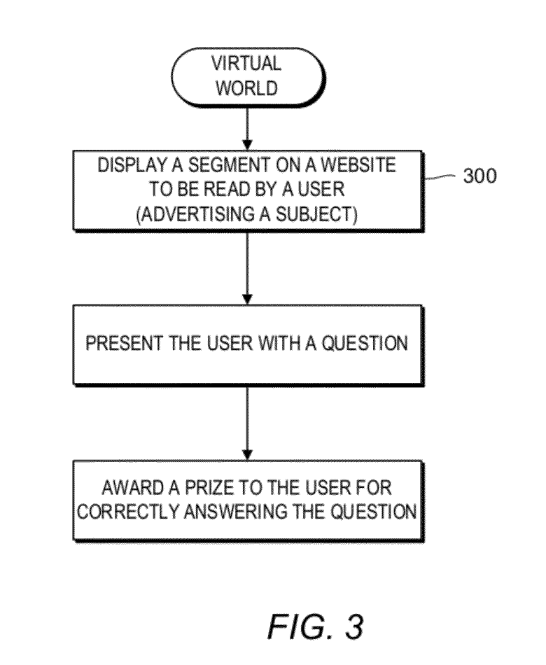

The above embodiment is referred to as “watch and win”, since the user watches the video and can then win a prize. An alternative embodiment, is called “read and win”. As the phrase suggests, similar to watch and win described above, rather than presenting the user with a video to watch, the computer system displays to the user a segment that the user reads at 300 in FIG. 3. For example, in this embodiment, the computer system may present the user with a virtual comic book about cornflakes and then ask questions about the cornflakes after the user has read the comic book. The computer system may generate the comic book, e.g., as a virtual comic book that can be played with either a Ooyola or Flash player.

Further information about the watch and win embodiment follows, and all of the techniques that can be used with watch and win can also be used with read and win.

Watch and win gives users additional reasons to visit Webkinz Newz or other portions of a website, and ultimately drives website traffic higher.

Advertising within Webkinz World can optionally be centered around movies: movies such as Bee Movie, Alvin and the Chipmunks ,etc. With the watch and win functionality in Webkinz World, advertisers are able to play movie trailers within Webkinz World, exposing their trailers to Webkinz World's users. This advertisement technique can optionally also occur in other portions of Webkinz World, such as on Webkinz Newz. Thus, rather than a movie trailer, the advertisement can be presented in a news-like environment.

For example, a user can access Webkinz Newz by navigating to the “pet of the month” page notifying users of a pet highlighted for that month in the Fun Section and click on the current month's video. More generally, according to one embodiment the user can click on or select any advertisement which is watch and win enabled, to see more detail about the advertisement, answer questions about the advertisement, and win some kind of prize for answering properly. Advertisements that are watch-and-win enabled can optionally have an appearance or otherwise be labeled on the website distinguish such advertisements from those that are not watch-and-win enabled. According to other embodiments, advertisements that are watch-and-win enabled are indistinguishable on their face from those that are not watch-and-win enabled.

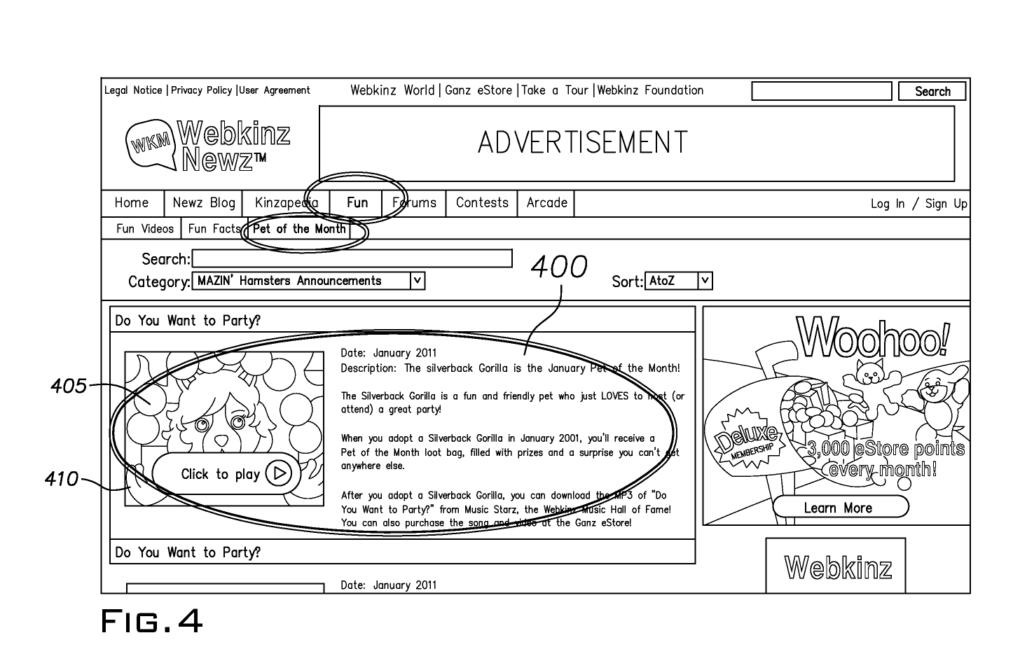

FIG. 4 shows an embodiment, in which trivia on the current pet of the month is shown as 400, along with the pet itself 405, and a “play” icon 410.

Step 1—User visits Webkinz Newz “Fun Section” Pet of the Month Section as shown in FIG. 4.

Step 2—User clicks most recent POM video.

Step 3—User is taken to most recent POM Video Page on Webkinz Newz where “Watch and Win” are featured.

According to an embodiment, the user can optionally not be redirected from another webpage to a portion of a website where a watch-and-win enabled advertisement is present. For example, watch and win can be used on Webkinz Newz as directed through the Webkinz World homepage. When this is done, even though the watch and win may be carried out on Webkinz Newz, the points that are accumulated may be usable on Webkinz World, and optionally only on Webkinz World.

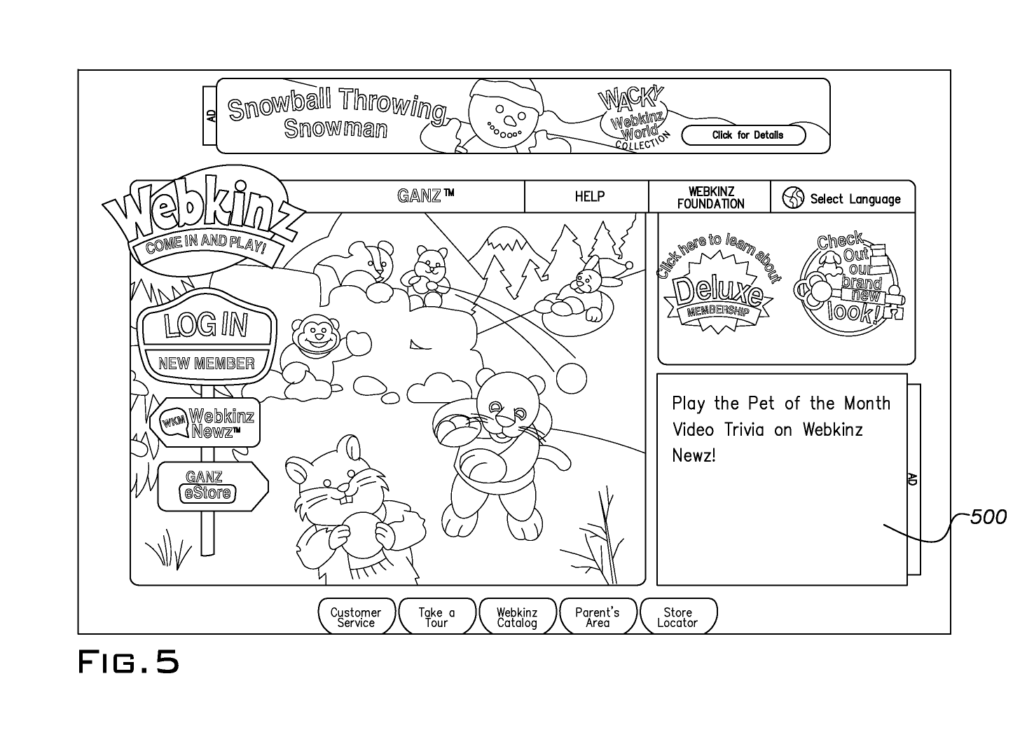

FIG. 5 illustrates how Webkinz World, which is the virtual world in which characters are animated in response to user-input commands and on which virtual points can be used, can link to the watch and Win page. For example, a link area 500 may link the user from Webkinz World to the Watch and Win page. This can be done as follows:

Step 1—User visits webkinz.com .

Step 2—User clicks “Watch and Win” advertisement in bottom right corner of homepage.

Step 3—User is taken to most recent POM Video Page on Webkinz Newz where “Watch and Win” are featured.

Users can be redirected from other ways into the Watch and Win page. For example the flash player within any of the websites may also redirect into the Watch and Win page. Any advertisements may also include links that may redirect in this way.

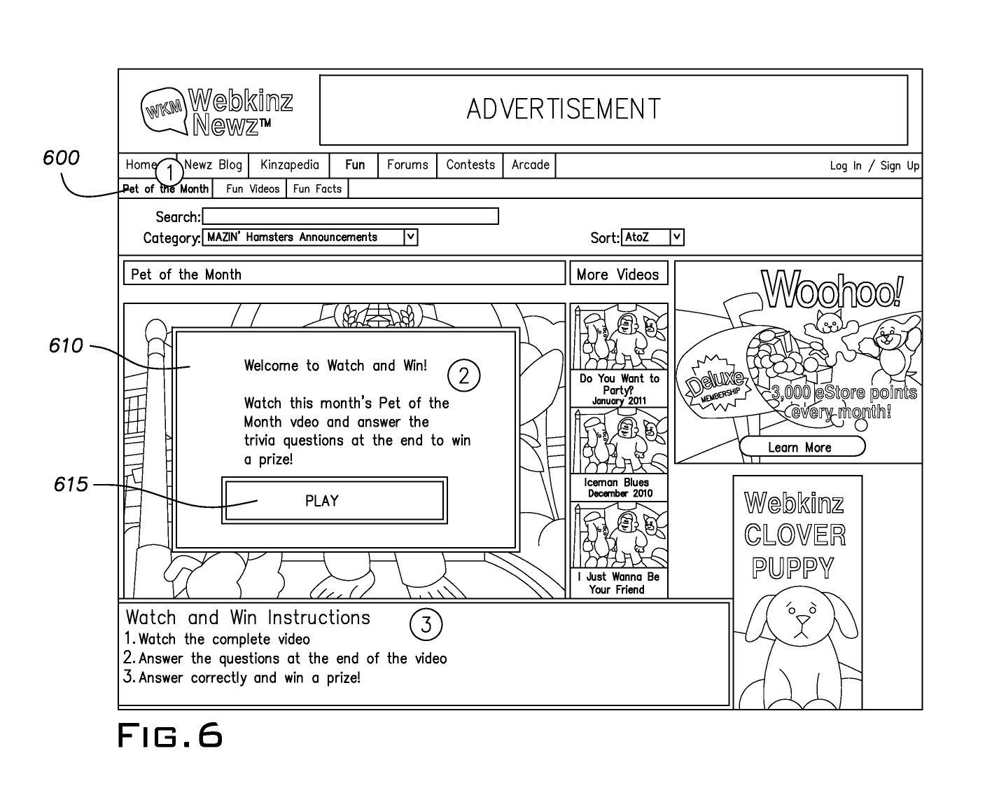

FIG. 6 shows another embodiment of the watch and win operation. In this embodiment, the watch and win is linked to the pet of the month 600, which when selected, brings up a message welcoming the user to the watch and win site. The message says for example “watch this month's pet of the month (“POM”) video and answer the trivia questions at the end to win a prize”. The user can play the video at 615, and then questions are asked to the user.

In one embodiment, the system may use the Ooyala video player, for example.

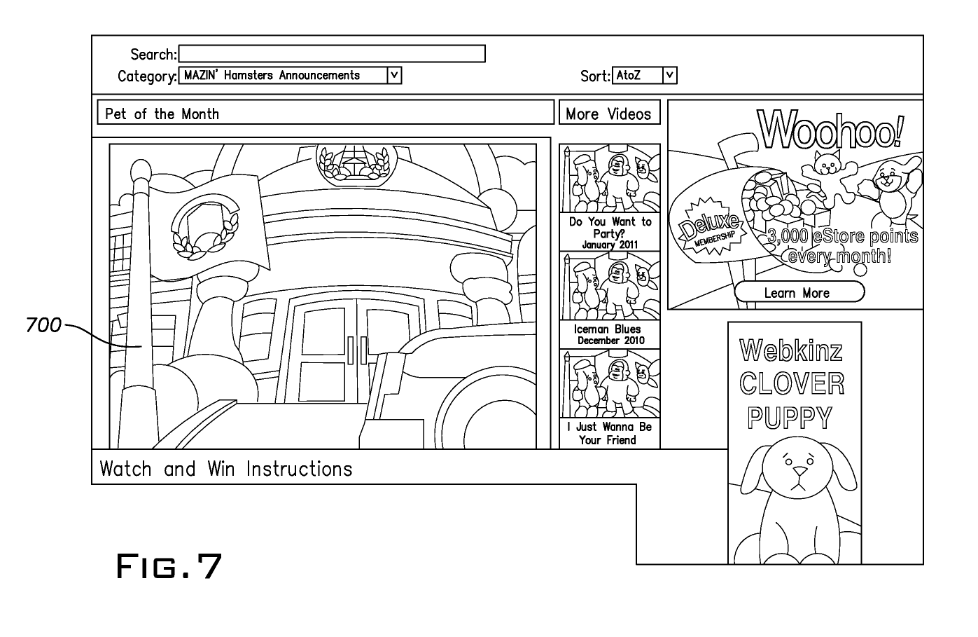

The Ooyala video player plays served video content including an advertisement before the actual POM video concerning the POM plays, as shown at 700 in FIG. 7. After the video has finished playing, a countdown to the trivia questions starts.

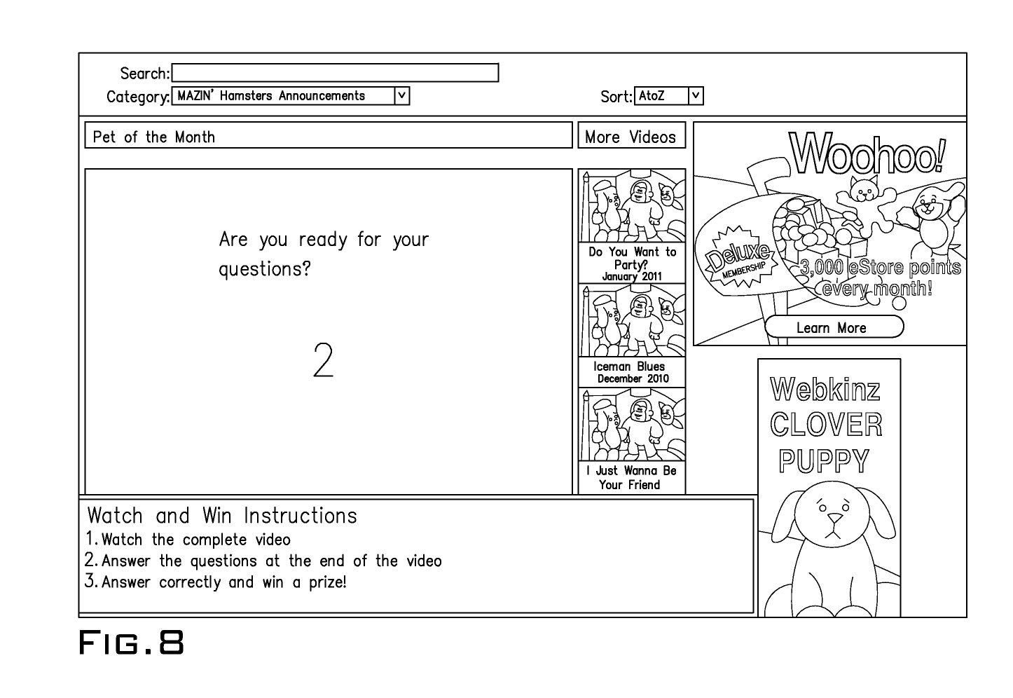

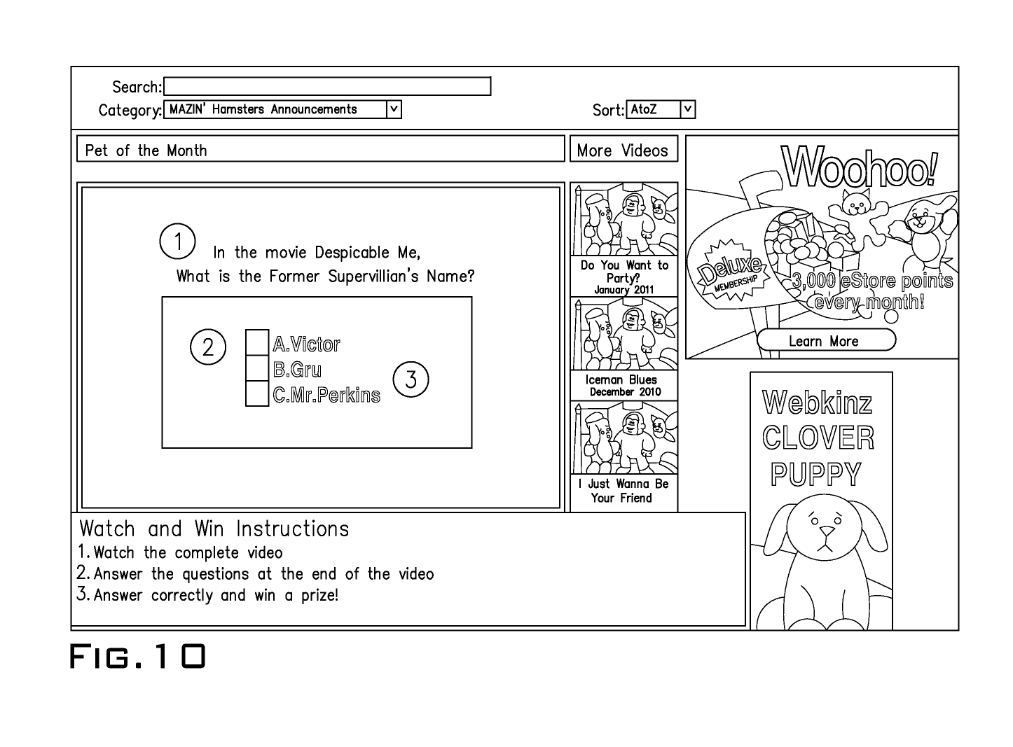

FIGS. 8-10 shows how once the video is finished, a countdown to the trivia section is displayed culminating in the trivia questions themselves in FIG. 10.

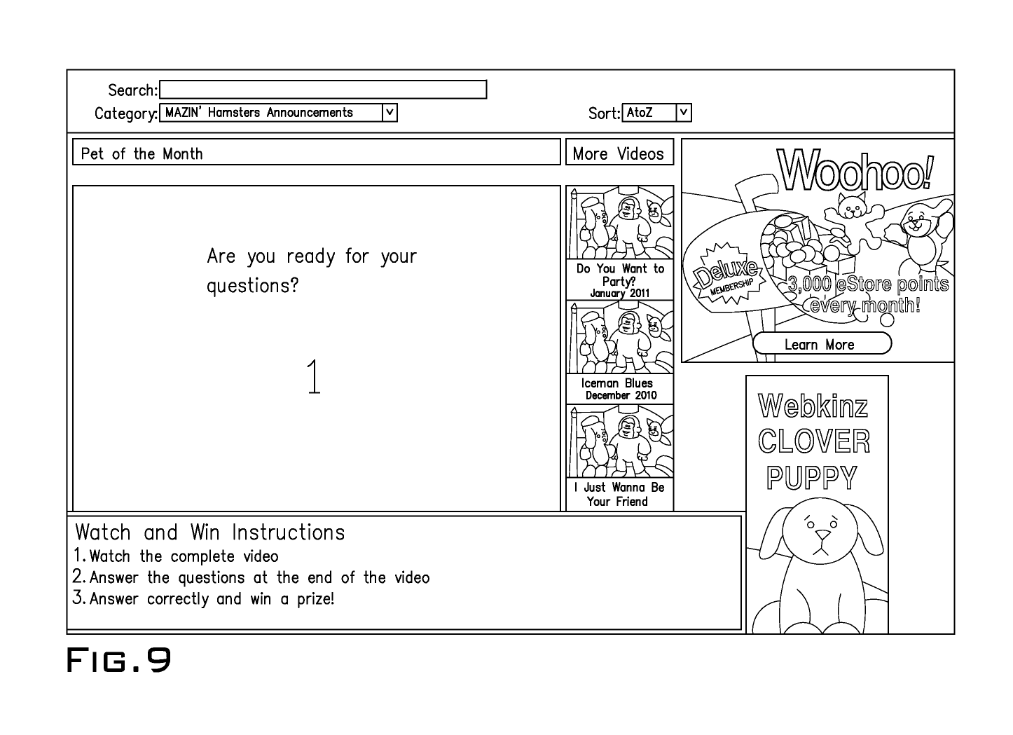

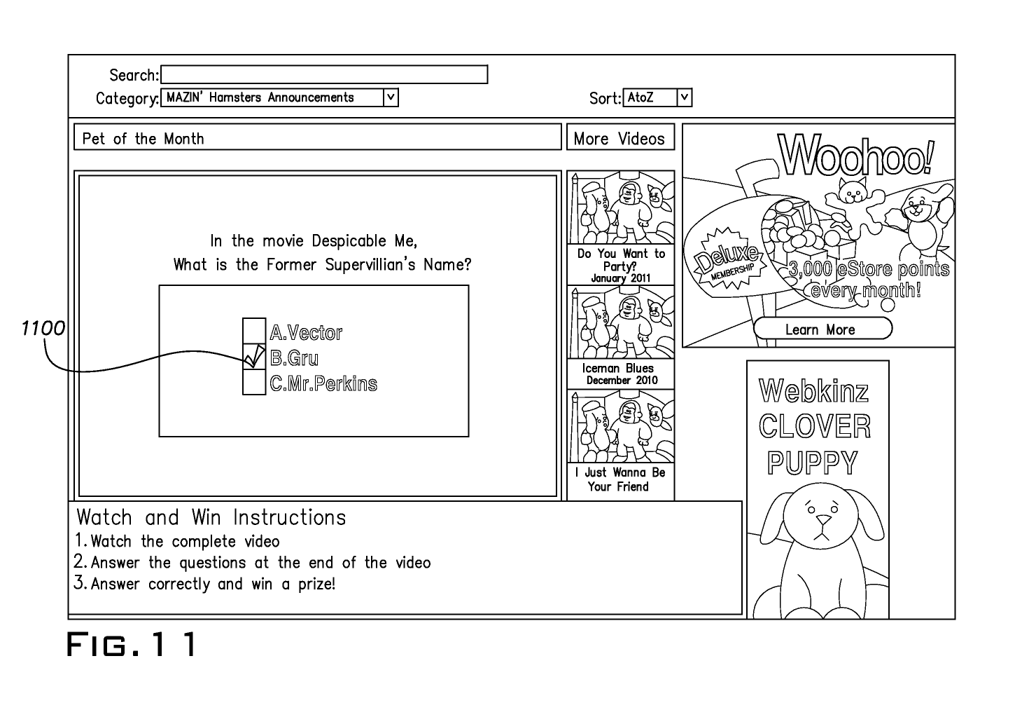

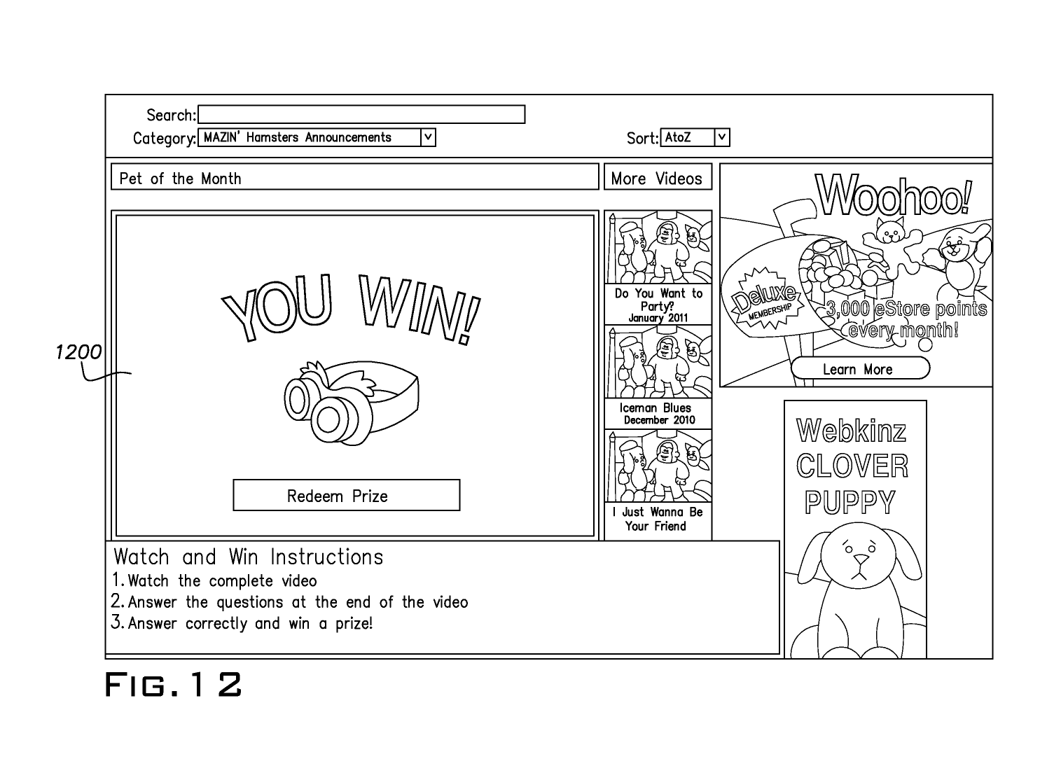

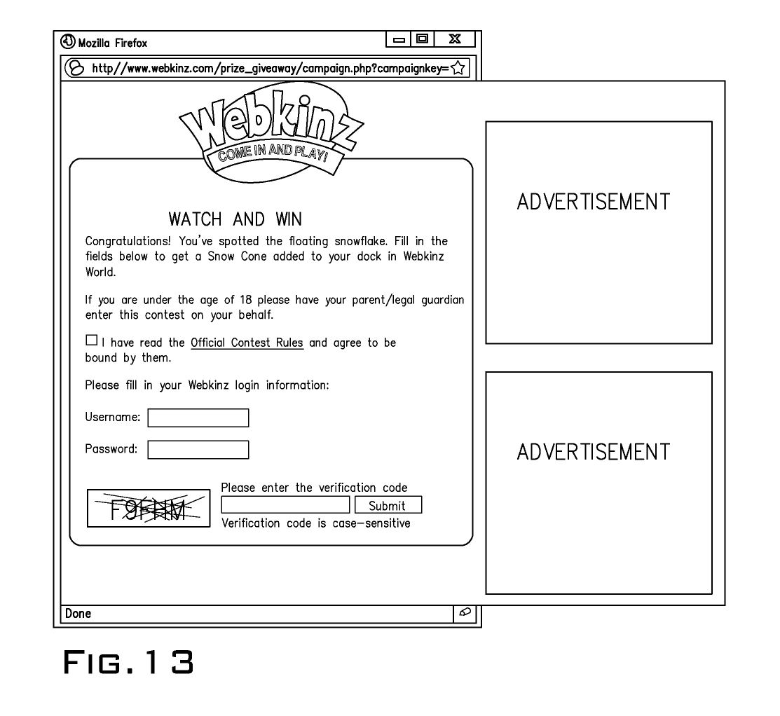

The countdown reads “ARE YOU READY FOR YOUR QUESTIONS?”, where there can be 3 questions. The countdown then continues in a count of 3, 2 (shown in FIG. 8), then 1 (shown in FIG. 9). After the countdown reaches a value of “1” trivia questions are presented as shown in FIG. 10. Questions are presented at the top of the video screen with functional check boxes beside each answer. Answers are ordered by letters (A,B,C . . . ). When a user answers a question, a checkmark 1100 appears beside their answer as shown in FIG. 11. If a user is successful in their answer, then a predetermined prize is awarded to their dock or otherwise credited to the user's account in Webkinz World, along with the message 1200 shown in FIG. 12. If a user clicks “Redeem Prize” then “Reward to Dock functionality” is initiated, as shown in FIG. 13.

The user enters their Webkinz World Username and Password, as well as other contest information needed. The username and password need not be entered if the user is already logged in.

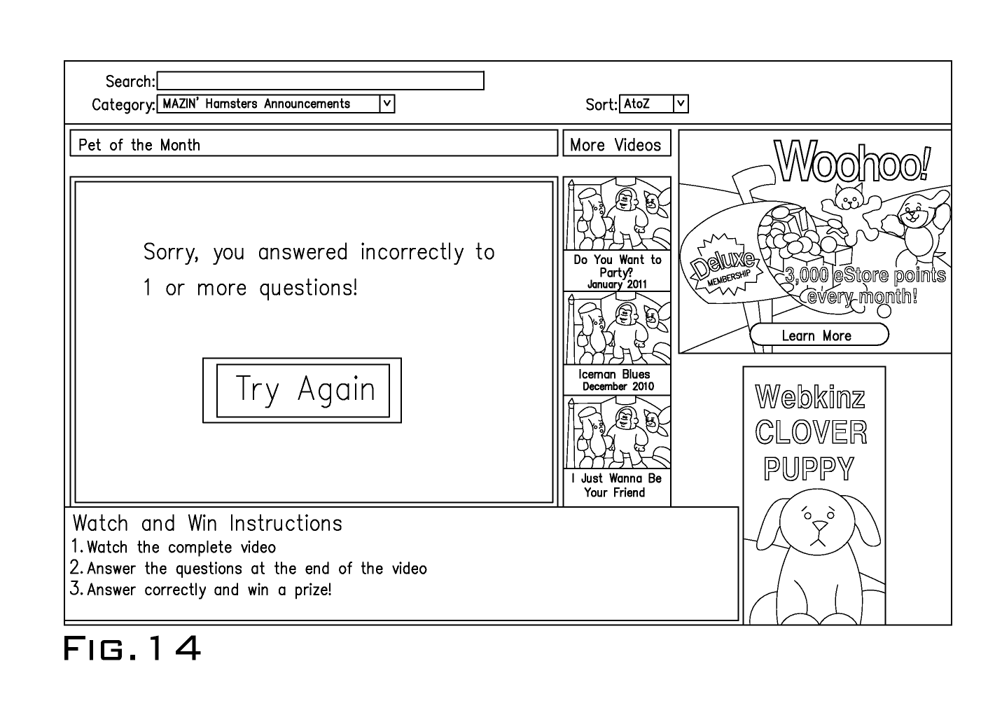

If a user is unsuccessful at the video trivia, then they are prompted to “try again”, see FIG. 14. Users can play as many times as they like, but can only receive 1 prize for each video watch.

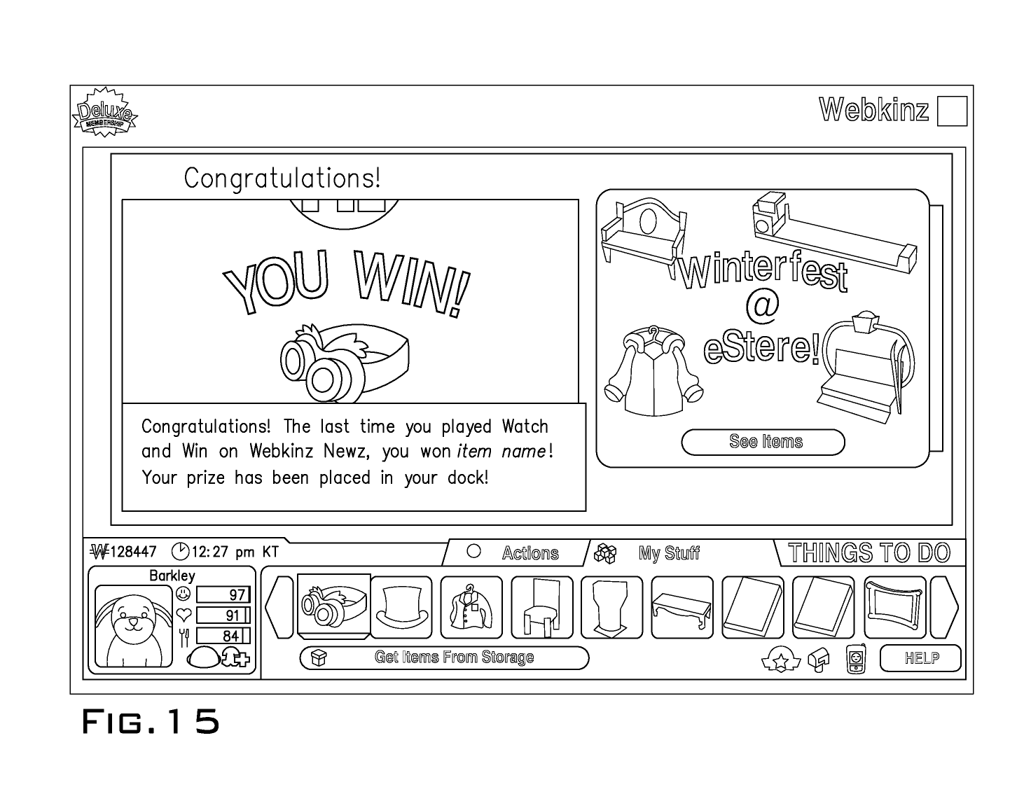

If a user is successful at watch and win, a “Congratulations” message is displayed the next time they log in to the separate Webkinz World website, shown as FIG. 15. The screen indicates that the last time the user played watch and win in Webkinz Newz (a separate site from Webkinz World) that the user won an item represented by the variable “itemname” and that the “itemname” has been placed in the dock.

In one embodiment, users must already be logged in to Webkinz World to play watch and win. In other embodiments, the user can play watch and win whether they are logged in, or not.

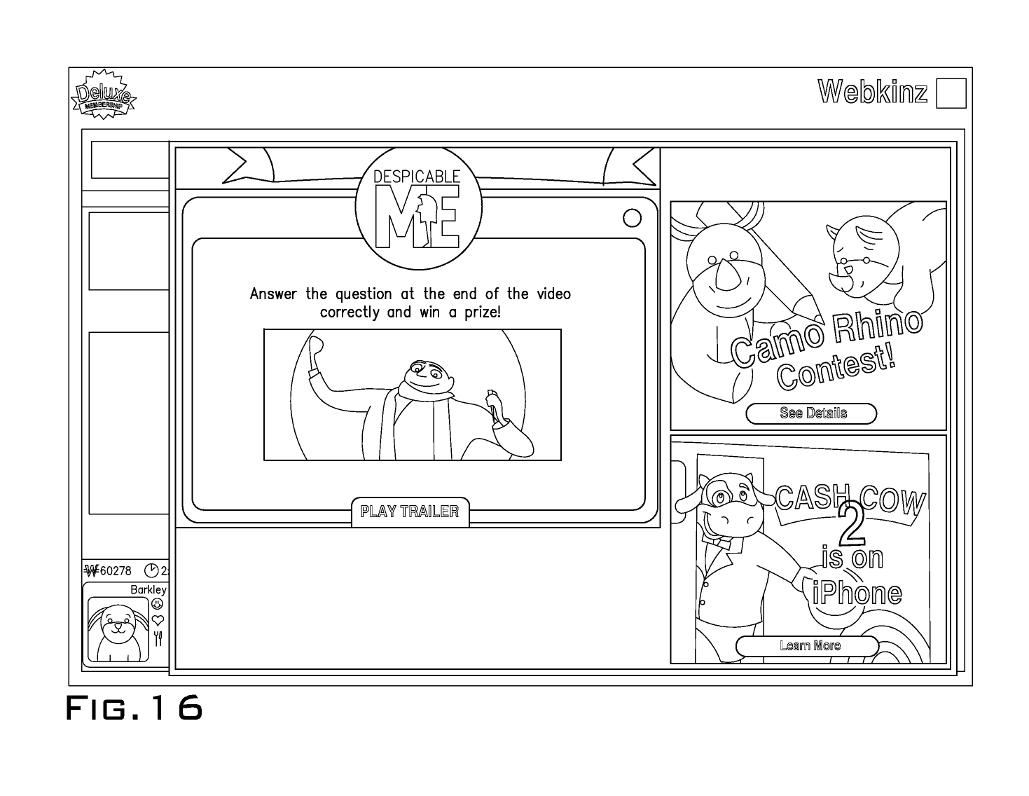

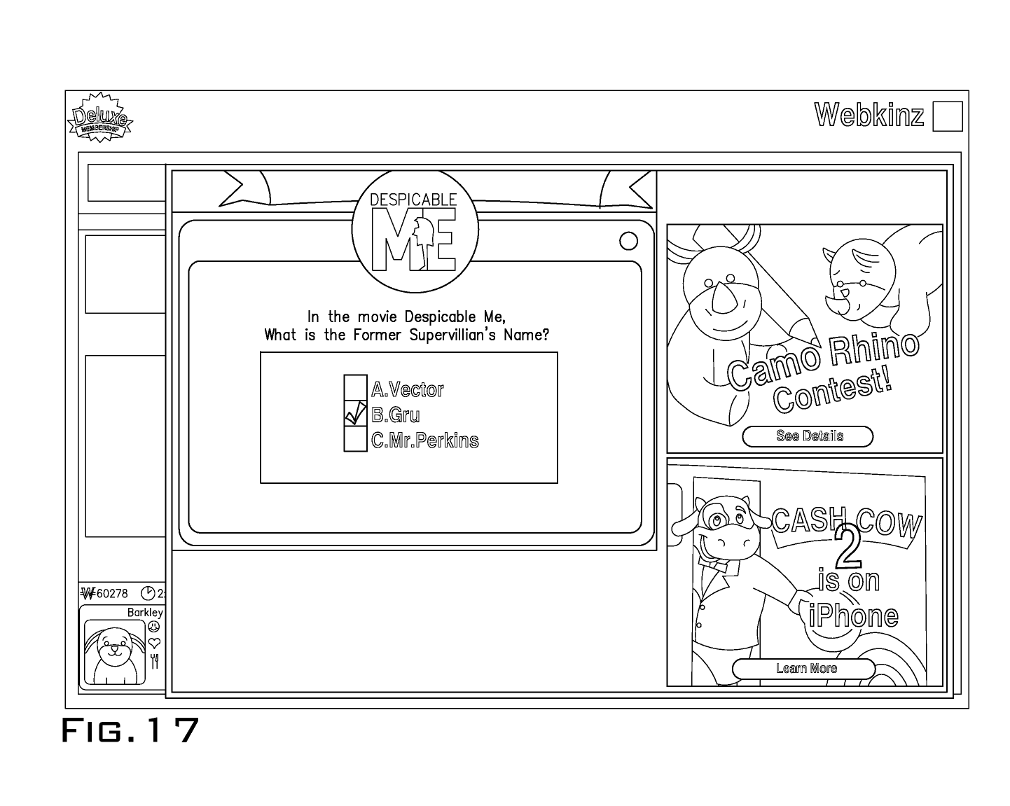

The above has shown an embodiment where watch and win is based on watching a pet of the month video. However, another watch and win embodiment may be watching a movie trailer, thereby encouraging the user to watch the movie trailer there and further thereby encouraging the advertisement. FIG. 16 shows a watch and win embodiment in which the movie trailer indicates that answering the question will enable the user to win a prize. The user watches the video, followed by the trivia session beginning in a similar way to that discussed above, with the countdown and the trivia questions. Upon answering the trivia questions properly, as shown in FIG. 17, the user is given a prize 440 that is added to their dock in Webkinz World for the correct answer. For such an embodiment, the video includes an advertisement for a movie, and the prize awarded to the user in response to correctly answering the question(s) that follow can be a virtual representation of a character or item from the movie, for example.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other items can be purchased and received in this way.

Also, the inventor intend that only those claims which use the words “means for” are intended to be interpreted under 35 USC 112, sixth paragraph. Moreover, no limitations from the specification are intended to be read into any claims, unless those limitations are expressly included in the claims. The computers described herein and included in the computer system may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method of advertising on a website, comprising:
interacting with a first website by a user by inputting a command into a user computer causing animation of a character on the first website, said command including a command for customizing said characters with a virtual item for the character, where said customizing requires carrying out at least one activity in order to obtain said virtual item; and
after the user has taken an action on the website to watch a first presentation about a first subject which is being advertised on the website, answering one or more questions about content included in the first presentation, and where a first virtual item is awarded to the user only when the one or more questions about the content are properly answered.

2. A method as in claim 1, wherein said first virtual item can also be purchased using virtual currency, and further comprising carrying out said at least one activity on the website to earn said virtual currency.

3. The method as in claim 1, wherein said action comprises viewing the first presentation on a second website, different than said first website, where said second website stores login information for said first website, and said first virtual item is automatically sent to said first website upon being awarded to the user.

4. The method as in claim 1, wherein said first virtual item is a virtual item that is related to a subject of the presentation.

5. The method as in claim 3, further comprising, the user logging into the first website, and automatically receiving a message from the first website indicating that the user has been awarded the first virtual item from the second website.

6. A method as in claim 4, wherein said subject of the first presentation is about a specific virtual pet usable on the first website, featured during a specified time, and said first virtual item is an item for the first virtual pet.

7. The method as in claim 4, wherein the subject of the first presentation is a food offered for sale, and said first virtual item is a virtual food that is the same kind of food offered for sale, which can be fed to said virtual character.

8. The method as in claim 4, wherein the subject of the first presentation is an advertisement about a movie, and the first virtual item is a virtual representation of a character or item from the movie.

9. The method as in claim 1, wherein said first presentation is a video, and said one or more questions are about the video.

10. The method as in claim 1, wherein said first presentation is an excerpt to be read, and said one or more questions are about said excerpt to be read.

11. A method of advertising on a website, comprising:
showing advertisements on a website, including at least one advertisement which is watch and win enabled;
receiving an indication that a user has clicked on one of said watch and win enabled advertisements;
responsive to receiving said indication, providing the user with a watch and win presentation that is about said advertisement that has been selected and provides a presentation about content of said advertisement;
subsequent to said providing said presentation, receiving an answer to multiple questions about said presentation, on the website from the user;
detecting whether the user has properly answered said multiple questions; and
providing on the website a reward for the user responsive to the user properly answering said multiple questions.

12. The method as in claim 11, wherein said watch and win presentation is a video, and said questions are about said video.

13. The method as in claim 11, wherein said watch and win presentation is an excerpt to be read, and said questions are about the excerpt.

14. The method as in claim 11, wherein said reward is a virtual item for use on the website.

15. The method as in claim 14, wherein said virtual item is for use on another website different than the website on which the watch and win presentation is shown, and said virtual item is used for customizing another virtual item on said another website.

16. The method as in claim 11, wherein said reward is virtual currency for use on said website.

17. The method as in claim 11, wherein said watch and win presentation is a presentation about a specific virtual pet usable on a first website, featured during a specified time, and said reward is an item for a first virtual pet controlled by the user on the first website.

18. The method as in claim 11, wherein said watch and win presentation is about a food offered for sale, and said reward is a virtual food and the same kind of food offered for sale, wherein said virtual food can be fed to a virtual character usable on a first website.

19. The method as in claim 11, wherein said watch and win presentation is an advertisement about a movie, and the reward is a virtual replica of a character or item from the movie.
